(19) United States
(12) Patent Application Publication
(10) Pub. No.: US 2017/0353649 A1
(43) Pub. Date: Dec. 7, 2017

(54) TIME OF FLIGHT RANGING FOR FLASH CONTROL IN IMAGE CAPTURE DEVICES

(71) Applicants: STMicroelectronics, Inc., Coppell, TX (US); STMircroelectronics (Research & Development) Limited, Buckinghashire (GB)

(72) Inventors: Xiaoyong Yang, San Jose, CA (US); John Kevin Moore, Edinburgh (GB)

(21) Appl. No.: 15/616,641

(22) Filed: Jun. 7, 2017

Related U.S. Application Data
(60) Provisional application No. 62/346,890, filed on Jun. 7, 2016.

(51) Int. Cl. H04N 5/235; G01S 17/10; G01S 17/02; H04N 5/225; G01S 7/486

(52) U.S. Cl. CPC H04N 5/2354; H04N 5/2256; G01S 7/4863; G01S 17/023; G01S 17/10

(57) ABSTRACT

A flash control circuit of an image capture device includes a time-of-flight ranging sensor configured to sense distances to a plurality of objects within an overall field of view of the time-of-flight ranging sensor. The time-of-flight sensor is configured to generate a range estimation signal including a plurality of sensed distances to the plurality of objects. Flash control circuitry is coupled to the time-of-flight ranging sensor to receive the range estimation signal and is configured to generate a flash control signal to control a power of flash illumination light based upon the plurality of sensed distances. The time-of-flight sensor may also generate a signal amplitude for each of the plurality of sensed objects, with the flash control circuitry generating the flash control signal to the control the power of the flash illumination based on the plurality of sensed distances and signal amplitudes.

### BACKGROUND

### Technical Field

The present disclosure relates generally to flash control in image capture devices such as digital cameras, and more specifically to the utilization of time of flight range detection in flash control of image capture devices.

### Description of the Related Art

In image capture devices, such as digital cameras, control of a flash device is primarily performed based on ambient light. When ambient light is low, the flash device is activated to illuminate an object for capture of an image of the object. Conversely, the flash device is deactivated when ambient light is high, making activation of the flash device unnecessary. The distance of the object being imaged from the image capture device, however, can greatly influence the effectiveness of the flash device and quality of the captured image. When the object is close to the image capture device and the flash device activated, the flash illumination of the object can be too strong and result in the captured image being “washed out,” such as where the object is a person's face, for example. If the object is farther away, the flash illumination of the object may be too weak, resulting in the object being too dark in the captured image.

Professional photographers will, for these reasons, measure a distance of an object from an image capture device and then adjust a flash device so that the flash illumination of the object has a proper intensity and is not too weak or too strong. In many everyday image capture devices, such as digital cameras in smart phones and other mobile devices, the control of the flash device is primarily triggered, or not triggered, based upon the detection of ambient light in the environment in which the mobile device and object being imaged are present. This can result in the issues noted above. In addition, where an object is located within a field of view of an image capture device also affects how effective the flash device is in properly illuminating the object being images. Multiple objects within the field of view can result in similar issues during image capture. In this situation, the flash device may possibly illuminate some objects too much so they appear washed out in the captured image while other objects are not illuminated enough and thus appear too dark in the captured image. There is a need for improved control of flash devices in image capture devices.

### BRIEF SUMMARY

In one embodiment of the present disclosure, a flash control circuit for an image capture device includes a time-of-flight ranging sensor configured to sense distances to a plurality of objects within an overall field of view of the time-of-flight ranging sensor. The time-of-flight sensor is configured to generate a range estimation signal including a plurality of sensed distances to the plurality of objects. Flash control circuitry is coupled to the time-of-flight ranging sensor to receive the range estimation signal. The flash control circuitry is configured to generate a flash control signal to control a power of flash illumination light based upon the plurality of sensed distances. The flash control circuitry may be configured to determine an average of the plurality of distances and to control the power of the flash illumination light based upon the average distance or to determine a number of the plurality of objects and to control the power of the flash illumination light based upon the determined number.

In one embodiment, the time-of-flight sensor is configured to transmit an optical pulse signal and to receive return optical pulse signals corresponding to portions of the transmitted optical pulse signal that reflect off the plurality of objects. The time-of-flight sensor in this embodiment is further configured to generate a signal amplitude for each of the plurality of sensed objects where the signal amplitude of each object is based on a number of photons of the return optical pulse signal received by the time-of-flight sensor for the object. The flash control circuitry may determine a reflectance of each of the plurality of objects based upon the sensed distance and the signal amplitude for the object and generate the flash control signal based upon the reflectance of each of the plurality of objects.

In one embodiment, the time-of-flight sensor includes a light source configured to transmit an optical pulse signal and a return array of light sensors, the return array of light sensors configured to receive return optical pulse signals corresponding to portions of the transmitted optical pulse signal that reflect off the plurality of objects. The light source may be a vertical-cavity surface-emitting laser and the return array of light sensors may be an array of single photon avalanche diodes (SPADs). The return array of SPADs may include a single array zone of light sensors or multiple zones. Each of multiple array zones of the return array is configured to receive return optical pulse signals from a corresponding one of a plurality of spatial zones of a receiving field of view of the time-of-flight sensor. The flash control circuitry is configured to determine positions of the plurality of sensed objects in the receiving field of view based upon which of the plurality of array zones sense an object, and to control the power of the flash illumination based upon the determined positions of the plurality of sensed objects.

### BRIEF DESCRIPTION OF THE SEVERAL VIEWS OF THE DRAWINGS

The foregoing and other features and advantages will become apparent from the following detailed description of embodiments, given by way of illustration and not limitation with reference to the accompanying drawings, in which:

FIG. 1 is a functional block diagram of an image capture device including flash control circuitry that controls flash illumination of multiple objects being imaged based upon time-of-flight (TOF) sensing according to one embodiment of the present disclosure.

FIG. 2 is a functional diagram illustrating the operation of the TOF ranging sensor of FIG. 1.

FIG. 3 is a functional block diagram illustrating in more detail one embodiment of the TOF ranging sensor of FIGS. 1 and 2.

FIG. 4A is a functional diagram of a single zone embodiment of the return single photon avalanche diode (SPAD) array contained in the TOF ranging sensor of FIG. 3.

FIG. 4B is a functional diagram of a multi zone embodiment of the return SPAD array contained in the TOF ranging sensor of FIG. 3;

FIGS. 5A and 5B are graphs illustrating operation of the TOF ranging sensor of FIG. 3 in detecting multiple objects within a field of view of the sensor;

FIG. 6 is a histogram generated by the TOF ranging sensor in the embodiment of FIGS. 5A and 5B which provides detected distance information for multiple objects within the field of view of the sensor; and

FIG. 7 is a diagram illustrating multiple spatial zones where the TOF ranging sensor of FIG. 3 is a multiple zone sensor.

### DETAILED DESCRIPTION

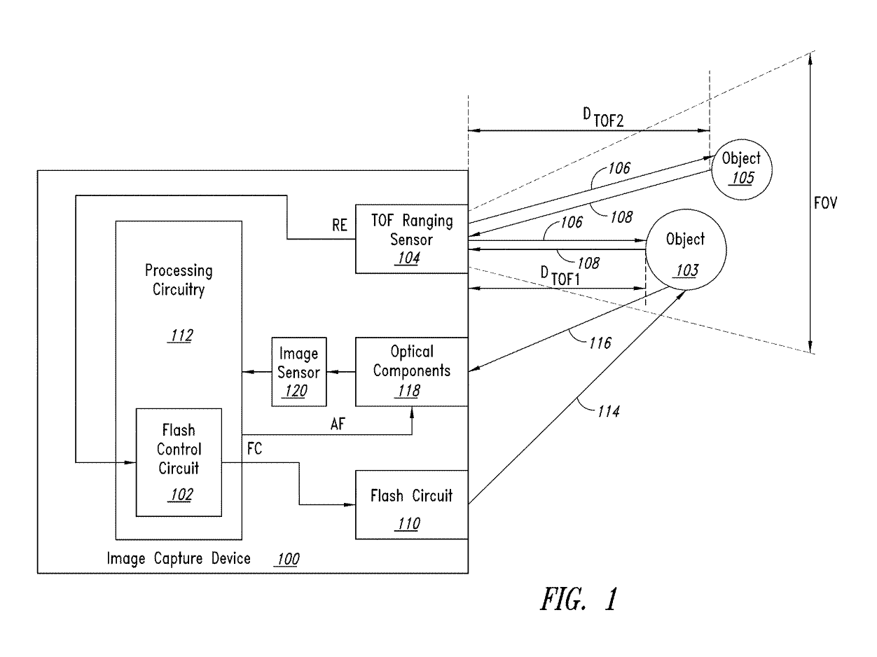

FIG. 1 is a functional block diagram of an image capture device 100 including flash control circuitry 102 that controls flash illumination of objects 103 and 105 being imaged based upon sensed distances D_{TOF1} and D_{TOF2} between each of the objects and the image capture device according to one embodiment of the present disclosure. A time of flight (TOF) ranging sensor 104 transmits an optical pulse signal 106 that is incident upon the objects 103 and 105 within an overall field of view FOV of the TOF ranging sensor. The transmitted optical pulse signal 106 reflects off the objects 103 and 105 and portions of the reflected pulse signals propagate back to the TOF ranging sensor 104 as return optical pulse signals 108. The TOF ranging sensor 104 determines the ranges or distances D_{TOF1} and D_{TOF2} between each of the objects 103, 105 and the image capture device 100, and the flash control circuitry 102 thereafter controls flash illumination of these objects based upon these determined distances. In one embodiment, a histogram based time-of-flight detection technique is utilized by the TOF ranging sensor 104 to detect distances to multiple objects present within multiple spatial zones or subfields of view within the overall field of view FOV of the sensor, as will be described in more detail below.

In the present description, certain details are set forth in conjunction with the described embodiments to provide a sufficient understanding of the present disclosure. One skilled in the art will appreciate, however, that the other embodiments may be practiced without these particular details. Furthermore, one skilled in the art will appreciate that the example embodiments described below do not limit the scope of the present disclosure, and will also understand that various modifications, equivalents, and combinations of the disclosed embodiments and components of such embodiments are within the scope of the present disclosure. Embodiments including fewer than all the components of any of the respective described embodiments may also be within the scope of the present disclosure although not expressly described in detail below. Finally, the operation of well-known components and/or processes has not been shown or described in detail below to avoid unnecessarily obscuring the present disclosure.

The TOF ranging sensor 104 generates first and second range estimation signals RE1 and RE2 indicating the sensed distances D_{TOF1} and D_{TOF2} that the objects 103 and 105, respectively, are positioned from the image capture device 100. The TOF ranging sensor 104 may generate more than two range estimation signals RE1, RE2, where more than two objects are present within the overall field of view FOV. All the range estimation signals generated by the TOF ranging sensor 104 are collectively designated as the range estimation signal RE in FIG. 1. In one embodiment, each of the range estimation signals RE1 and RE2 includes a detected or sensed distance D_{TOF} to the detected object in the field of view FOV and also includes a signal amplitude SA (not shown) of the corresponding return optical pulse signal 108. Utilizing the sensed distances D_{TOF1} and D_{TOF2} and the signal amplitude SA of the return optical pulse signals 108, which are independent of the reflectance of each of the objects 103, 105, information about the reflectance of each of the objects may be determined and utilized in combination with the detected distances and positions of the detected objects to control flash illumination of the objects 103 and 105, as will also be discussed in more detail below.

The flash control circuitry 102 receives the range estimation signal RE and utilizes the range estimation signal to control the operation of a flash circuit 110. In the embodiment of FIG. 1, the flash control circuitry 102 is shown as being part of processing circuitry 112 contained in the image capture device 100. The processing circuitry 112 also includes other circuitry for controlling the overall operation of the image capture device 100. The specific structure and functionality of the processing circuitry 112 will depend on the nature of the image capture device 100. For example, the image capture device 100 may be a stand-alone digital camera or may be digital camera components contained within another type of electronic device, such as a smart phone or tablet computer. Thus, in FIG. 1 the processing circuitry 112 represents circuitry contained in the image capture device 100 but also generally represents circuitry of other electronic devices, such as a smart phone or tablet computer, where the image capture device 100 is part of another electronic device. For example, where the image capture device 100 is part of a mobile device like a smart phone, the processing circuitry 112 controls the overall operation of the smart phone and also executes applications or “apps” that provide specific functionality for a user of the mobile device. The flash control circuitry 102 and TOF ranging sensor 104 may together be referred to as a flash control circuit for the image capture device 100. The flash circuit 110 that generates the flash illumination light 114 may also be considered to part of this flash control circuit of the image capture device 100.

In operation, the flash control circuitry 102 generates a flash control signal FC to control the flash circuit 110 to illuminate the objects 103, 105 when the image capture device 100 is capturing an image of the objects. This illumination of the objects 103, 105 by the flash circuit 110 is referred to as flash illumination in the present description and corresponds to flash illumination light 114 that is generated by the flash circuit and which illuminates the objects. Some of the flash illumination light 114 reflects off the objects 103, 105 and propagates back towards the image capture device 100 as return light 116.

The image capture device 100 includes optical components 118 that route and guide this return light 116 to an image sensor 120 that captures an image of the objects 103, 105. The optical components 118 would typically include a lens and may also include filtering components and autofocusing components for focusing captured images on the image sensor 120. The image sensor 120 may be any suitable type of image sensor, such as a charge coupled device (CCD) type image sensor or a CMOS image sensor, and captures an image of the objects 103, 105 from the light provided by the optical components 118. The image sensor 120 provides captured images to the processing circuitry 112, which controls the image sensor to capture images and would typically store the captured images and provide other image capture related processing of the captured images.

In operation, the flash control circuitry 102 controls the flash circuit 110 to adjust the power of the flash illumination light 114 based upon the sensed distances to an object or the multiple objects, namely distances D_{TOF1} and D_{TOF2} in the example of FIG. 1, the number and positions of detected multiple objects 103, 105 within the overall field of view FOV, and information about the reflectance of each of the multiple objects based on the signal amplitude SA and sensed distance associated with each of the objects, as will be explained in more detail below. The flash control circuitry 102 generates the flash control signal FC to control the flash circuit 110 to generate the light 114 having a power or other characteristic that is adjusted based upon these sensed parameters. Two objects 103, 105 are illustrated merely by way of example in FIG. 1, and more than two objects are detected by the TOF ranging sensor 104 in some embodiments of the present disclosure, as will be described in more detail below. In addition, the processing circuitry 112 generates an autofocus signal AF based upon the sensed distance or distances D_{TOF} to focus the image sensor 120 on the objects being imaged. The precise manner in which the processing circuitry 112 generates the autofocus signal AF using the sensed distance or distances D_{TOF} may vary.

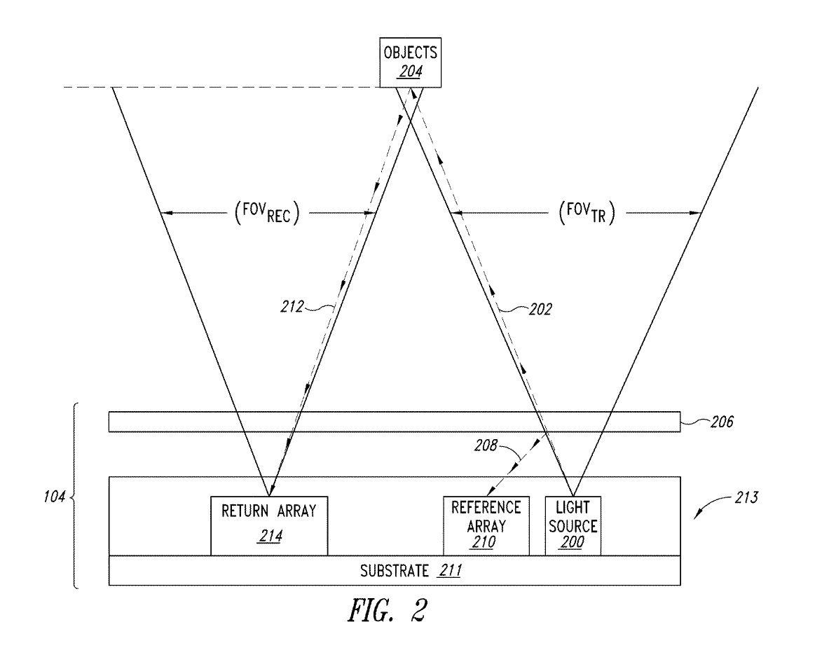

FIG. 2 is a functional diagram illustrating components and operation of the TOF ranging sensor 104 of FIG. 1. The TOF ranging sensor 104 may be a single chip that includes a light source 200 and return and reference arrays of photodiodes 214, 210. Alternatively, these components may be incorporated within the circuitry of the image capture device 100 or other circuitry or chip within an electronic device including the image capture device. The light source 200 and the return and reference arrays 214, 210 are formed on a substrate 211. In one embodiment, all the components of the TOF ranging sensor 104 are contained within the same chip or package 213, with all components except for the light source 200 being formed in the same integrated circuit within this package in one embodiment.

The light source 200 transmits optical pulse signals having a transmission field of view FOV_{TR} to irradiate objects within the field of view. A transmitted optical pulse signal 202 is illustrated in FIG. 2 as a dashed line and irradiates an object 204 within the transmission field of view FOV_{TR} of the light source 200. In addition, a reflected portion 208 of the transmitted optical pulse signal 202 reflects off an integrated panel, which may be within a package 213 or may be on a cover 206 of the image capture device 100. The reflected portion 208 of the transmitted pulse is illustrated as reflecting off the cover 206, however, it may be reflected internally within the package 213.

The cover 206 may be glass, such as on a front of a mobile device associated with a touch panel or the cover may be metal or another material that forms a back cover of the electronic device. The cover will include openings to allow the transmitted and return signals to be transmitted and received through the cover if not a transparent material.

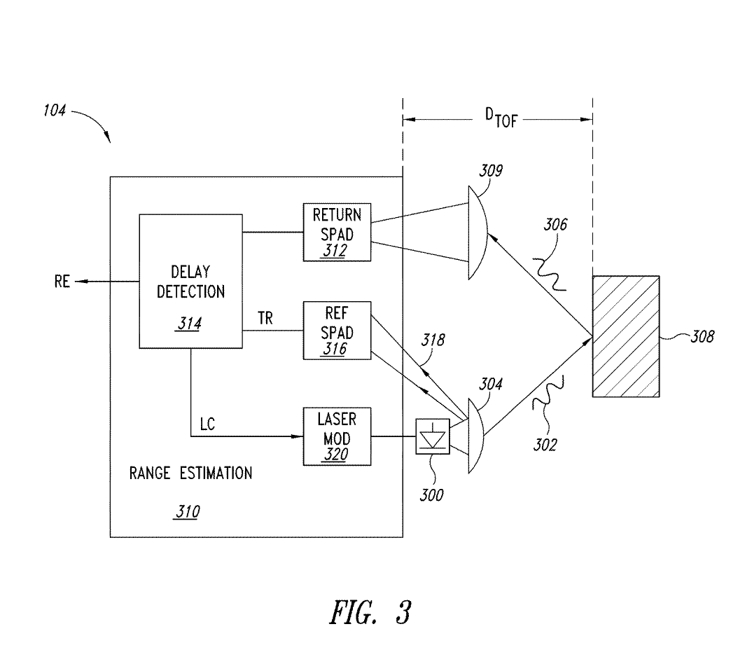

The reference array 210 of light sensors detects this reflected portion 208 to thereby sense transmission of the optical pulse signal 208. A portion of the transmitted optical pulse signal 202 reflects off objects 204 within the transmission field of view FOV_{TR} as return optical pulse signals 212 that propagate back to the TOF ranging sensor 104. The TOF ranging sensor 104 includes a return array 214 of light sensors having a receiving field of view FOV_{REC} that detects the return optical pulse signals 212. The field of view FOV of FIG. 1 includes the transmitting and receiving fields of view FOV_{TR} and FOV_{REC}. The TOF ranging sensor 104 then determines respective distances D_{TOF} between the TOF ranging sensor and the objects 204 based upon the time between the reference array 210 sensing transmission of the optical pulse signal 202 and the return array 214 sensing the return optical pulse signal 212. The TOF ranging sensor 104 also generates a signal amplitude SA for each of the detected objects 204, as will be described in more detail with reference to FIG. 3.

FIG. 3 is a more detailed functional block diagram of the TOF ranging sensor 104 of FIGS. 1 and 2 according to one embodiment of the present disclosure. In the embodiment of FIG. 3, the TOF ranging sensor 104 includes a light source 300, which is, for example, a laser diode such as a vertical-cavity surface-emitting laser (VCSEL) for generating the transmitted optical pulse signal designated as 302 in FIG. 3. The transmitted optical pulse signal 302 is transmitted in the transmission field of view FOV_{TR} of the light source 300 as discussed above with reference to FIG. 2. In the embodiment of FIG. 3, the transmitted optical pulse signal 302 is transmitted through a projection lens 304 to focus the transmitted optical pulse signals 302 so as to provide the desired field of view FOV_{TR}. The projection lens 304 can be used to control the transmitted field of view FOV_{TR} of the sensor 104 and is an optional component, with some embodiments of the sensor not including the projection lens.

The reflected or return optical pulse signal is designated as 306 in FIG. 3 and corresponds to a portion of the transmitted optical pulse signal 302 that is reflected off objects within the field of view FOV_{TR}. One such object 308 is shown in FIG. 3. The return optical pulse signal 306 propagates back to the TOF ranging sensor 104 and is received through a return lens 309 that provides the desired return or receiving field of view FOV_{REC} for the sensor 104, as described above with reference to FIG. 2. The return lens 309 in this way is used to control the field of view FOV_{REC} of the sensor 104. The return lens 309 directs the return optical pulse signal 306 to range estimation circuitry 310 for generating the imaging distance D_{TOF} and signal amplitude SA for each object 308. The return lens 309 is an optional component and thus some embodiments of the TOF ranging sensor 104 do not include the return lens.

In the embodiment of FIG. 3, the range estimation circuitry 310 includes a return single-photon avalanche diode (SPAD) array 312, which receives the returned optical pulse signal 306 via the lens 309. The SPAD array 312 corresponds to the return array 214 of FIG. 2 and typically includes a large number of SPAD cells (not shown), each cell including a SPAD for sensing a photon of the return optical pulse signal 306. In some embodiments of the TOF ranging sensor 104, the lens 309 directs reflected optical pulse signals 306 from separate spatial zones within the field of view FOV_{REC} of the sensor to certain groups of SPAD cells or zones of SPAD cells in the return SPAD array 312, as will be described in more detail below.

Each SPAD cell in the return SPAD array 312 provides an output pulse or SPAD event when a photon in the form of the return optical pulse signal 306 is detected by that cell in the return SPAD array. A delay detection circuit 314 in the range estimation circuitry 310 determines a delay time between transmission of the transmitted optical pulse signal 302 as sensed by a reference SPAD array 316 and a SPAD event detected by the return SPAD array 312. The reference SPAD array 316 is discussed in more detail below. The SPAD event detected by the return SPAD array 312 corresponds to receipt of the return optical pulse signal 306 at the return SPAD array. In this way, by detecting these SPAD events, the delay detection circuit 314 estimates an arrival time of the return optical pulse signal 306. The delay detection circuit 314 then determines the time of flight TOF based upon the difference between the transmission time of the transmitted optical pulse signal 302 as sensed by the reference SPAD array 316 and the arrival time of the return optical pulse signal 306 as sensed by the SPAD array 312. From the determined time of flight TOF, the delay detection circuit 314 generates the range estimation signal RE (FIG. 1) indicating the detected distance D_{TOF} between the hand 308 and the TOF ranging sensor 104.

The reference SPAD array 316 senses the transmission of the transmitted optical pulse signal 302 generated by the light source 300 and generates a transmission signal TR indicating detection of transmission of the transmitted optical pulse signal. The reference SPAD array 316 receives an internal reflection 318 from the lens 304 of a portion of the transmitted optical pulse signal 302 upon transmission of the transmitted optical pulse signal from the light source 300, as discussed for the reference array 210 of FIG. 2. The lenses 304 and 309 in the embodiment of FIG. 3 may be considered to be part of the glass cover 206 or may be internal to the package 213 of FIG. 2. The reference SPAD array 316 effectively receives the internal reflection 318 of the transmitted optical pulse signal 302 at the same time the transmitted optical pulse signal is transmitted. In response to this received internal reflection 318, the reference SPAD array 316 generates a corresponding SPAD event and in response thereto generates the transmission signal TR indicating transmission of the transmitted optical pulse signal 302.

The delay detection circuit 314 includes suitable circuitry, such as time-to-digital converters or time-to-analog converters, to determine the time-of-flight TOF between the transmission of the transmitted optical pulse signal 302 and receipt of the reflected or return optical pulse signal 308. The delay detection circuit 314 then utilizes this determined time-of-flight TOF to determine the distance D_{TOF} between the hand 308 and the TOF ranging sensor 104. The range estimation circuitry 310 further includes a laser modulation circuit 320 that drives the light source 300. The delay detection circuit 314 generates a laser control signal LC that is applied to the laser modulation circuit 320 to control activation of the laser 300 and thereby control transmission of the transmitted optical pulse signal 302. The range estimation circuitry 310 also determines the signal amplitude SA based upon the SPAD events detected by the return SPAD array 312. The signal amplitude SA is based on the number of photons of the return optical pulse signal 306 received by the return SPAD array 312. The closer the object 308 is to the TOF ranging sensor 104 the greater the sensed signal amplitude SA, and, conversely, the farther away the object the smaller the sensed signal amplitude.

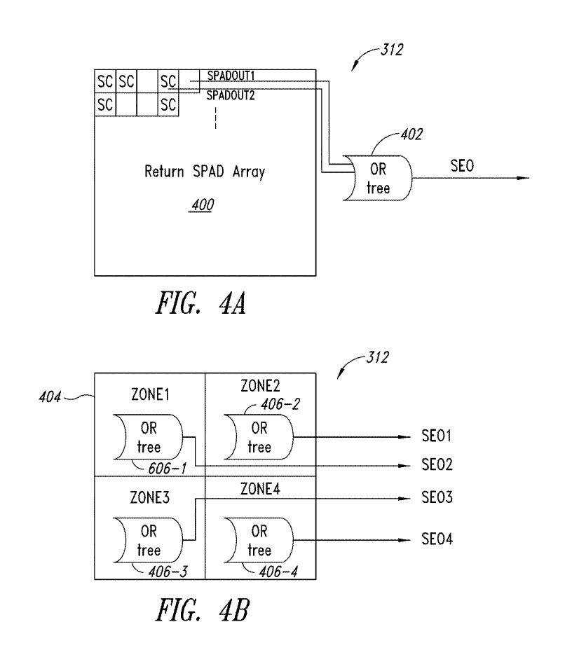

FIG. 4A is a functional diagram of a single zone embodiment of the return SPAD array 312 of FIG. 3. In this embodiment, the return SPAD array 312 includes a SPAD array 400 including a plurality of SPAD cells SC, some of which are illustrated and labeled in the upper left portion of the SPAD array. Each of these SPAD cells SC has an output, with two outputs labeled SPADOUT1, SPADOUT2 shown for two SPAD cells by way of example in the figure. The output of each SPAD cell SC is coupled to a corresponding input of an OR tree circuit 402. In operation, when any of the SPAD cells SC receives a photon from the reflected optical pulse signal 306, the SPAD cell provides an active pulse on its output. Thus, for example, if the SPAD cell SC having the output designated SPADOUT2 in the figure receives a photon from the reflected optical pulse signal 306, then that SPAD cell will pulse the output SPADOUT2 active. In response to the active pulse on the SPADOUT2, the OR tree circuit 402 will provide an active SPAD event output signal SEO on its output. Thus, whenever any of the SPAD cells SC in the return SPAD array 400 detects a photon, the OR tree circuit 402 provides an active SEO signal on its output. In the single zone embodiment of FIG. 4A, the TOF ranging sensor 104 may not include the lens 309 and the return SPAD array 312 corresponds to the return SPAD array 400 and detects photons from reflected optical pulse signals 306 within the single field of view FOV_{REC} (FIG. 2) of the sensor.

FIG. 4B is a functional diagram of a multiple zone embodiment of the return SPAD array 312 FIG. 3. In this embodiment, the return SPAD array 312 includes a return SPAD array 404 having four array zones ZONE1-ZONE4, each array zone including a plurality of SPAD cells. Four zones ZONE1-ZONE4 are shown by way of example and the SPAD array 404 may include more or fewer zones. A zone in the SPAD array 404 is a group or portion of the SPAD cells SC contained in the entire SPAD array. The SPAD cells SC in each zone ZONE1-ZONE4 have their output coupled to a corresponding OR tree circuit 406-1 to 406-4. The SPAD cells SC and outputs of these cells coupled to the corresponding OR tree circuit 406-1 to 406-4 are not shown in FIG. 4B to simplify the figure.

In this embodiment, each of zones ZONE1-ZONE4 of the return SPAD array 404 effectively has a smaller subfield of view corresponding to a portion of the overall field of view FOV_{REC} (FIG. 2). The return lens 309 of FIG. 3 directs return optical pulse signals 306 from the corresponding spatial zones or subfields of view within the overall field of view FOV_{REC} to corresponding zones ZONE1-ZONE4 of the return SPAD array 404. In operation, when any of the SPAD cells SC in a given zone ZONE1-ZONE4 receives a photon from the reflected optical pulse signal 306, the SPAD cell provides an active pulse on its output that is supplied to the corresponding OR tree circuit 406-1 to 406-4. Thus, for example, when one of the SPAD cells SC in the zone ZONE1 detects a photon that SPAD cell provides and active pulse on its output and the OR tree circuit 406-1, in turn, provides an active SPAD event output signal SEO1 on its output. In this way, each of the zones ZONE1-ZONE4 operates independently to detect SPAD events (i.e., receive photons from reflected optical pulse signals 306 in FIG. 3).

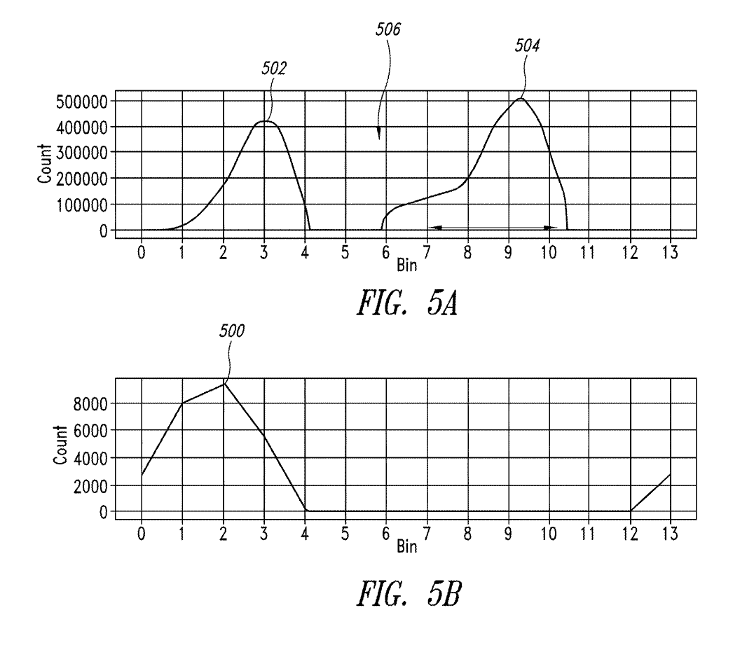

FIGS. 5A and 5B are graphs illustrating operation of the TOF ranging sensor 104 of FIG. 2 in detecting multiple objects within the field of view FOV of the TOF ranging sensor 104 of FIGS. 2 and 3. The graphs of FIGS. 5A and 5B are signal diagrams showing a number of counts along a vertical axis and time bins along a horizontal axis. The number of counts indicates a number of SPAD events that have been detected in each bin, as will be described in more detail below. These figures illustrate operation of a histogram based ranging technique implemented by the TOF ranging sensor 104 of FIGS. 1-3 according to an embodiment of the present disclosure. This histogram based ranging technique allows the TOF ranging sensor 104 to sense or detect multiple objects within the field of view FOV of the TOF ranging sensor.

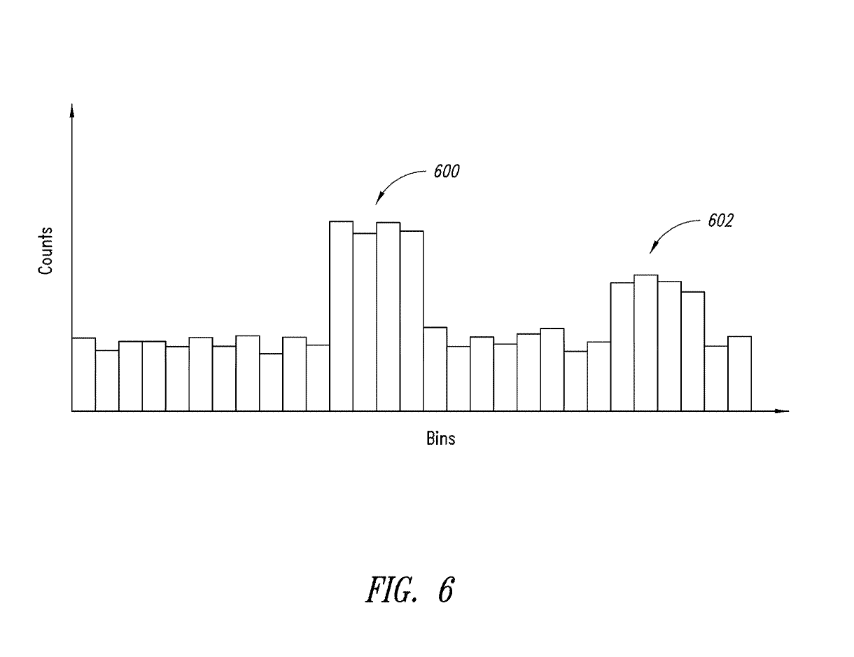

This histogram based ranging technique is now described in more detail with reference to FIGS. 3, 4A, 4B, 5A and 5B. In this technique, more than one SPAD event is detected each cycle of operation, where the transmitted optical pulse signal 302 is transmitted each cycle. SPAD events are detected by the return SPAD array 312 (i.e., return SPAD array 400 or 404 of FIGS. 4A, 4B) and reference SPAD array 316, where a SPAD event is an output pulse provided by the return SPAD array indicating detection of a photon. Thus, an output pulse from the OR tree circuit 402 of FIG. 4A or one of the OR tree circuits 406-1 to 406-4 of FIG. 4B. Each cell in the SPAD arrays 312 and 3216 will provide an output pulse or SPAD event when a photon is received in the form of the return optical pulse signal 306 for target SPAD array 212 and internal reflection 318 of the transmitted optical pulse signal 302 for the reference SPAD array 316. By monitoring these SPAD events an arrival time of the optical signal 306, 318 that generated the pulse can be determined. Each detected SPAD event during each cycle is allocated to a particular bin, where a bin is a time period in which the SPAD event was detected. Thus, each cycle is divided into a plurality of bins and a SPAD event detected or not for each bin during each cycle. Detected SPAD events are summed for each bin over multiple cycles to thereby form a histogram in time as shown in FIG. 6 for the received or detected SPAD events. The delay detection circuit 314 of FIG. 3 or other control circuitry in the TOF ranging sensor 104 implements this histogram-based technique in one embodiment of the sensor.

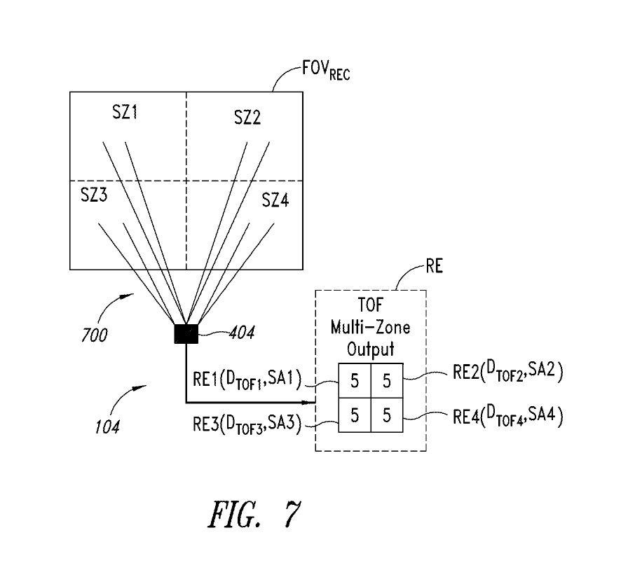

FIGS. 5A and 5B illustrate this concept over a cycle. Multiple cells in each of the SPAD arrays 312 and 316 may detect SPAD events in each bin, with the count of each bin indicating the number of such SPAD events detected in each bin over a cycle. FIG. 5B illustrates this concept for the internal reflection 318 of the transmitted optical pulse signal 302 as detected by the reference SPAD array 316. The sensed counts (i.e., detected number of SPAD events) for each of the bins shows a peak 500 at about bin 2 with this peak being indicative of the transmitted optical pulse signal 302 being transmitted. FIG. 5A illustrates this concept for the reflected or return optical pulse signal 306, with there being two peaks 502 and 504 at approximately bins 3 and 9. These two peaks 502 and 504 (i.e., detected number of SPAD events) indicate the occurrence of a relatively large number of SPAD events in the bins 3 and 9, which indicates reflected optical pulse signals 306 reflecting off a first object causing the peak at bin 3 and reflected optical pulse signals reflecting off a second object at a greater distance than the first object causing the peak at bin 9. A valley 506 formed by a lower number of counts between the two peaks 502 and 504 indicates no additional detected objects between the first and second objects. Thus, the TOF ranging sensor 104 is detecting two objects, such as the objects 103 and 105 of FIG. 1, within the FOV of the sensor in the example of FIGS. 7A and 7B. The two peaks 502 and 504 in FIG. 5A are shifted to the right relative to the peak 500 of FIG. 5B due to the time-of-flight of the transmitted optical pulse signal 302 in propagating from the TOF ranging sensor 104 to the two objects 103, 105 within the FOV but at different distances from the TOF ranging sensor.

FIG. 6 illustrates a histogram generated by TOF ranging sensor 104 over multiple cycles. The height of the rectangles for each of the bins along the horizontal axis represents the count indicating the number of SPAD events that have been detected for that particular bin over multiple cycles of the TOF ranging sensor 104. As seen in the histogram of FIG. 6, two peaks 600 and 602 are again present, corresponding to the two peaks 602 and 604 in the single cycle illustrated in FIG. 5A. From the histogram of FIG. 6, either the TOF ranging sensor 104 determines a distance D_{TOF} to each of the first and second objects 103, 105 in the FOV of the TOF ranging sensor. In addition, the TOF ranging sensor 104 also generates the signal amplitude SA for each of the objects 103, 105 based upon these counts, namely the number of photons or SPAD events generated by the return SPAD array 312 in response to the return optical pulse signal 306.

FIG. 7 is a diagram illustrating multiple spatial zones within the receiving field of view FOV_{REC} where the TOF ranging sensor 104 is a multiple zone sensor including the return SPAD array 404 of FIG. 4B. In this embodiment, the receiving field of view FOV_{REC} includes four spatial zones SZ1-SZ4 as shown. Thus, the four spatial zones SZ1-SZ4 collectively form the receiving field of view FOV_{REC} of the TOF ranging sensor 104. The transmitted optical pulse signal 302 (FIG. 3) illuminates these four spatial zones SZ1-SZ4 within the receiving field of view FOV_{REC}. The number of spatial zones SZ corresponds to the number of array zones ZONE1-ZONE4 in the return SPAD array 404 of FIG. 4B. Where the return SPAD array 404 includes a different number of array zones ZONE1-ZONE4 or a different arrangement of the array zones within the return SPAD array, then the number and arrangement of the corresponding spatial zones SZ within the overall field of view FOV_{REC} will likewise vary. In such a multiple zone TOF ranging sensor 104 as functionally illustrated in FIG. 7, the return lens 309 (FIG. 3) is configured to route return optical pulse signals 306 from each of the spatial zones SZ within the overall field of view FOV_{REC} to a corresponding array zone ZONE1-ZONE4 of the return SPAD array 404 of FIG. 4B. This is represented in the figure through the pairs of lines 700 shown extending from the return SPAD array 404 to each of the spatial zones SZ1-SZ4.

Each of the array zones ZONE1-ZONE4 outputs respective SPAD event output signals SEO1-SEO4 as previously described with reference to FIG. 4B, and the TOF ranging sensor 104 accordingly calculates four different imaging distances D_{TOF1}-D_{TOF4}, one for each of the spatial zones SZ1-SZ4. Thus, in this embodiment the range estimation signal RE generated by the TOF ranging sensor 104 includes four different values for the four different detected imaging distances D_{TOF1}-D_{TOF4}. Each of these detected imaging distances D_{TOF1}-D_{TOF4} is shown as being part of the generated range estimation signal RE to have a value 5. This would indicate objects in each of the spatial zones SZ1-SZ4 are the same distance away, or there is one object covering all the spatial zones. The value 5 was arbitrarily selected merely to represent the value of each of the detected imaging distances D_{TOF1}-D_{TOF4} and to illustrate that in the example of FIG. 7 each of these detected imaging distances has the same value. As seen in FIG. 7, the TOF ranging sensor 104 also outputs the signal amplitude SA signal for each of the spatial zones SZ and corresponding array zones ZONE. Thus, for the spatial zone SZ1 the TOF ranging sensor 104 generates the range estimation signal RE1 including the sensed distance D_{TOF1} and signal amplitude SA1 generated based on SPAD events detected by array zone ZONE1. The signals RE2-RE4 for spatial zones SZ2-SZ4 and array zones ZONE2-ZONE4 are also shown.

Referring back to FIG. 1, embodiments of the overall operation of the flash control circuitry 102 in controlling the flash circuit 110 based upon the range estimation signal RE generated by the TOF ranging sensor 104 will now be described in more detail. Initially, a user of the image capture device 100 activates the image capture device 100 and directs the image capture device to place an image scene within a field of view of the device. The image scene is a scene that the user wishes to image, meaning capture a picture of with the image capture device 100. The field of view the image capture device 100 is not separately illustrated in FIG. 1, but is analogous to the field of view FOV shown for the TOF ranging sensor 104 for the optical components 118 of the image capture device 118. The field of view of the image capture device 100 would of course include or overlap with the field of view FOV of the TOF ranging sensor 104 so that the sensor can detect the distances to objects within the field of view of the image capture device (i.e., of the optical components 118).

When the image capture device 100 is activated, the TOF ranging sensor 104 is activated and begins generating a starting histogram such as the histogram illustrated in FIG. 6. The TOF ranging sensor 104 then utilizes this starting histogram to detect the distance D_{TOF} to an object or multiple objects 103, 105 in the image scene to be captured. The TOF ranging sensor 104 may utilize a variety of suitable methods for processing the starting histogram to detect the distance or distances D_{TOF} to objects 103, 105 in the image scene, as will be understood by those skilled in the art. For example, detection of maximum values of peaks in the starting histogram or the centroid of the peaks in the starting histogram may be utilized in detecting objects in the imaging scene. The TOF ranging sensor 104 may perform ambient subtraction as part of generating this starting histogram, where ambient subtraction is a method of adjusting the values of detected SPAD events using detected SPAD events during cycles of operation of the TOF ranging sensor 104 when no transmitted optical pulse signal 106 is being transmitted. The TOF ranging sensor 104 may utilize ambient subtraction in order to compensate for background or ambient light in the environment of the imaging scene containing the objects being imaged, as will be appreciated by those skilled in the art.

The TOF ranging sensor 104 processes the generated histogram to generate the range estimation signal RE including a distance D_{TOF} and signal amplitude SA for each detected object. Thus, in the example of FIG. 1 the TOF ranging sensor 104 generates a range estimation signal RE including a first range estimation signal RE1 including the sensed distance D_{TOF1} and signal amplitude SA1 for the object 103 and further including a second range estimation signal RE2 including the sensed distance D_{TOF2} and signal amplitude SA2 for the object 105.

The flash control circuitry 102 receives the first and second range estimation signals RE1, RE2 from the TOF ranging sensor 104 and then controls the flash circuit 110 to adjust the power of the flash illumination light 114 based upon these range estimation signals. The flash control circuitry 102 generally controls the flash circuit 110 based upon multiple detected objects sensed by the TOF ranging sensor 104 and thus based upon the range estimate signal RE generated by this sensor. The specific manner in which the flash control circuitry 102 controls the flash circuit 110 based upon the range estimation signal RE varies in different embodiments of the present disclosure. In general, when sensed objects are father away, the flash control circuitry 102 controls the flash circuit 110 to increase the power of light 114 transmitted by the flash circuit to illuminate objects being imaged. Conversely, the flash control circuitry 102 in general controls the flash circuit 11 to decrease the power of the flash illumination light 114 if sense objects are nearer the image capture device.

Where the TOF ranging sensor 104 detects multiple objects, the flash control circuitry 102 may adjust or control the power of the flash illumination light 114 generated by the flash circuit 110 in a variety of different ways, as will now be described in more detail. In the following description, the flash control circuitry 102 is described, for the sake of brevity, as controlling or adjusting the power of the flash illumination light 114, even though the flash control circuitry actually generates the flash control signal FC to control the flash circuit 110 to thereby generate the flash illumination light 114 having a power based upon these sensed parameters. In one embodiment, the flash control circuitry 102 balances the power of the flash illumination light 114 by using the average of the sensed distances D_{TOF} to multiple sensed objects. The flash control circuitry 102 can adjust the flash illumination light 114 to a maximum power when the sensed distance D_{TOF} to a nearest one of multiple sensed objects is greater than a threshold value. The TOF ranging sensor 104 has a maximum range or distance D_{TOF-MAX} beyond which the sensor cannot accurately sense the distances to objects. Thus, in one embodiment the flash control circuitry 102 also adjusts the flash illumination light 114 to a maximum power where all objects within the field of view FOV of the TOF ranging sensor 104 are beyond this maximum range D_{TOF-MAX}.

As discussed above, the TOF ranging sensor 104 generates a signal amplitude SA in addition to the sensed distance D_{TOF} for each of multiple objects detected by the sensor. The signal amplitude SA is related to the number of photons of the return optical pulse signal 306 (FIG. 3) sensed by the return SPAD array 400 (FIG. 4A) or by each zone of the multiple zone return SPAD array 404 (FIG. 4B) as previously discussed. In one embodiment, the flash control circuitry 102 utilizes the sensed signal amplitude SA and sensed distance D_{TOF} for each object to estimate a reflectivity of the object, and then controls the power of the flash illumination light 114 based upon this estimated reflectivity. For example, where the sensed distance D_{TOF} for a detected object is relatively small and the corresponding signal amplitude SA is also small, the flash control circuitry 102 may determine the sensed object is a low reflectivity object. The flash control circuitry 102 would then increase the power of the flash illumination light 114 to adequately illuminate the objects for image capture. Conversely, if the sensed distance D_{TOF} for a detected object is relatively large and the corresponding signal amplitude SA is also large, the flash control circuitry 102 may determine the sensed object is a high reflectivity object. In this situation, the flash control circuitry 102 decreases the power of the flash illumination light 114 so that the objects do not appear too bright in the captured image.

In other embodiments, the flash control circuitry 102 controls the power of the flash illumination light 114 based on other parameters of sensed objects. For example, in one embodiment the flash control circuitry 102 adjusts or controls the power of the flash illumination light 114 based upon the locations or positions of the objects within the overall field of view FOV_{REC}. Where the multiple zone return SPAD array 404 of FIG. 4B is used, the position of a sensed object within the overall field of view FOV_{REC} is known based upon which array zones ZONE sense an object. For example, where the array zone ZONE1 senses an object the flash control circuitry 102 determines an object is located in spatial zone SZ1 of FIG. 7 and thus in the upper left corner of the overall field of view FOV_{REC}. Where sensed objects are not positioned near the center of the overall field of view FOV_{REC}, the flash control circuitry 102 in one embodiment increases the power of the flash illumination light 114 relative to the power of the flash illumination light that would be provided based simply on the detected distances D_{TOF} to the objects.

The flash control circuitry 102 determines where objects are positioned within the overall field of view FOV_{REC} based upon which zones ZONE of the multiple zone return SPAD array 404 of FIG. 4B sense an object. The return SPAD array 404 includes only four zones ZONE, but this embodiment is better illustrated where the array includes more than four zones, such as where the array includes a 4×4 array of sixteen zones. In this case, when the objects are sensed only in a zone or several zones in one corner of the overall field of view FOV_{REC} the flash control circuitry 102 increases the power of the flash illumination light 114. In yet another embodiment, the flash control circuitry 102 adjusts the power of the flash illumination light 114 to balance the power based upon the number of sensed objects within the overall field of view FOV_{REC}.

In the single zone return SPAD array 400 embodiment of FIG. 4A, the TOF ranging sensor 104 need not include the return lens 309 of FIG. 3. In order to get a more accurate estimate of the reflectance of an object in the infrared spectrum, the object must be assumed to cover the full field of view of the sensor. In the multiple zone embodiments, the different zones of the return SPAD array effectively have separate, smaller fields of view as discussed with reference to FIG. 7. In these embodiments, there is more confidence of smaller objects at distance D_{TOF} covering the entire field of view of a given zone. The multiple zone lensed solution discussed with reference to FIG. 4B provides information on where objects are within an image scene. Finally, it should be noted that the TOF ranging sensor 104 need not use the histogram-based ranging technique described with reference to FIGS. 5 and 6. The TOF ranging sensor 104 could use other time-of-flight techniques to extract range information. For example, analog delay locked loop based systems, time-to-amplitude/analog converters, and so on could be utilized by the TOF ranging sensor 104 to detect distances to objects instead of the described histogram-based ranging technique.

While in the present disclosure embodiments are described including a ranging device including SPAD arrays, the principles of the circuits and methods described herein for calculating a distance to an object could be applied to arrays formed of other types of photon detection devices.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not to be limited to the embodiments of the present disclosure.

1. A flash control circuit for an image capture device, comprising:
a time-of-flight ranging sensor configured to sense distances to a plurality of objects within an overall field of view of the time-of-flight ranging sensor and to generate a range estimation signal including a plurality of sensed distances to the plurality of objects; and
flash control circuitry coupled to the time-of-flight ranging sensor to receive the range estimation signal, the flash control circuitry configured to generate a flash control signal to control a power of flash illumination light based upon the plurality of sensed distances.

2. The flash control circuit of claim 1, wherein the flash control circuitry is configured to determine an average of the plurality of distances and generate the flash control signal based upon the average distance.

3. The flash control circuit of claim 1, wherein the flash control circuitry is further configured to determine a number of the plurality of objects and to generate the flash control signal based upon the determined number.

4. The flash control circuit of claim 1, wherein the time-of-flight sensor is further configured to transmit an optical pulse signal and to receive return optical pulse signals corresponding to portions of the transmitted optical pulse signal that reflect off the plurality of objects, and wherein the time-of-flight sensor is further configured to generate the range estimation signal including a signal amplitude for each of the plurality of sensed objects, the signal amplitude of each object being based on a number of photons of the return optical pulse signal received by the time-of-flight sensor for the object.

5. The flash control circuit of claim 4, wherein the flash control circuitry is further configured to determine a reflectance of each of the plurality of objects based upon the sensed distance and the signal amplitude for the object, and to generate the flash control signal based on the reflectance of each of the plurality of objects.

6. The flash control circuit of claim 1, wherein the time-of-flight sensor further comprises:
a light source configured to transmit an optical pulse signal; and
a return array of light sensors, the return array of light sensors configured to receive return optical pulse signals corresponding to portions of the transmitted optical pulse signal that reflect off the plurality of objects.

7. The flash control circuit of claim 6, wherein the light source comprises a vertical-cavity surface-emitting laser and wherein the return array of light sensors comprises an array of single photon avalanche diodes.

8. The flash control circuit of claim 6, wherein the return array comprises a single zone of light sensors, the single zone of light sensor configured to receive return optical pulse signals from the overall field of view of the time-of-flight sensor.

9. The flash control circuit of claim 6, wherein the return array comprises a plurality of array zones, each array zone of the return array being configured to receive return optical pulse signals from a corresponding one of a plurality of spatial zones of a receiving field of view of the time-of-flight sensor.

10. The flash control circuit of claim 9, wherein the flash control circuitry is further configured to determine positions of the plurality of sensed objects in the receiving field of view based upon which of the plurality of array zones sense an object, and is further configured to generate the flash control signal based upon the determined positions of the plurality of sensed objects.

11. The flash control circuit of claim 1, where the time-of-flight ranging sensor is further configured to generate a histogram and to determine the plurality of sensed distances from the histogram.

12. An image capture device, comprising:
a time-of-flight ranging sensor configured to sense distances to a plurality of objects within an overall field of view of the time-of-flight ranging sensor and to generate a range estimation signal including a plurality of sensed distances to the plurality of objects;
flash control circuitry coupled to the time-of-flight ranging sensor to receive the range estimation signal, the flash control circuitry configured to generate a flash control signal to control a power of flash illumination light based upon the plurality of sensed distances;
a flash circuit coupled to the flash control circuitry to receive the flash control signal, the flash control circuit configured to generate the flash illumination light based on the flash control signal;
an image sensor; and
processing circuitry coupled to the flash control circuitry and the image sensor, the processing circuitry configured to control the image sensor to capture an image of the plurality of objects.

13. The image capture device of claim 12, wherein the time-of-flight ranging sensor comprises:
a light source configured to transmit an optical pulse signal;
a reference array of light sensors configured to sense transmission of the optical pulse signal;
a return array of light sensors, the return array of light sensors configured to receive return optical pulse signals corresponding to portions of the transmitted optical pulse signal that reflect off the plurality of objects.

14. The image capture device of claim 13, wherein the time-of-flight sensor further comprises control circuitry coupled to the light source, reference array and return array, the control circuitry configured to implement a histogram-based ranging technique to sense the distances to the plurality of objects.

15. The image capture device of claim 12, wherein the processing circuitry comprises one of smart phone and tablet computer circuitry.

16. A method of controlling an image capture device, the method comprising:
transmitting an optical pulse signal;
receiving return optical pulse signals corresponding to portions of the transmitted optical pulse signal that reflect off a plurality of objects within a field of view of the image capture device;
sensing distances to the plurality of objects based upon a time between transmitting the optical pulse signal and receiving the return optical pulse signals;
controlling a power of flash illumination light based upon the sensed distances of the plurality of objects.

17. The method of claim 16 further comprising:
determining positions of the plurality of objects within the field of view; and
controlling the power of the flash illumination light based upon the determined positions.

18. The method of claim 16 further comprising:
determining a reflectance of each of the plurality of objects within the field of view; and
controlling the power of the flash illumination light based upon the determined reflectance of each of the plurality of objects.

19. The method of claim 16, wherein transmitting the optical pulse signal comprises generating an infrared optical pulse signal.

20. The method of claim 16, wherein transmitting the optical pulse signal comprises transmitting a plurality of optical pulse signals, each pulse signal being transmitted during a cycle of operation.
